(19) United States
(12) Patent Application Publication
(10) Pub. No.: US 2005/0036164 A1
(43) Pub. Date: Feb. 17, 2005

(54) Image forming apparatus, image processing device, and image forming method

(75) Inventors: Yoshihito Hiroe, Mishima-shi (JP); Masashi Honda, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/886,054

(22) Filed: Jul. 8, 2004

(30) Foreign Application Priority Data
Jul. 8, 2003 (JP) 2003-193896

(51) Int. Cl. H04N 1/40; G06K 15/02

(52) U.S. Cl. 358/1.9; 358/2.1

(57) ABSTRACT

There is disclosed a digital copying apparatus of the present invention, which subjects an image signal input from a scanner to image processing based on an adjustment value set associated with buttons of an operation panel to output an image, and the buttons are displayed after adjusting the adjustment value set.

### CROSS-REFERENCE TO RELATED APPLICATIONS

This application is based upon and claims the benefit of priority from prior Japanese Patent Application No. 2003-193896, filed Jul. 8, 2003, the entire contents of which are incorporated herein by reference.

### BACKGROUND OF THE INVENTION

1. Field of the Invention

The present invention relates to an image forming apparatus which subjects, for example, an input image signal to specific image processing to form an image.

2. Description of the Related Art

In recent years, in an image forming apparatus, an image has been processed based on an image processing mode in which the relation in density or the like between a document image and a copied image is adjusted.

However, it has been difficult to obtain an accurate output by adjustment of each item of the image processing mode by a user in actual conditions. To solve the problem, there is a function of selecting a document mode.

In the document mode selection function, a plurality of set value sets are prepared beforehand in accordance with types of copying objects such as a text document including only texts, a photograph document including only photographs, and a document including the texts and photographs. An optional set (document mode) is selected from these set value sets by the user or automatically by an image forming apparatus. The user may also select the document mode, and finely adjust basic set values in the document mode.

With respect to a user who frequently uses set values slightly different from those of the set value set of each document mode, it is considered that the set value set of each document mode is customized to set values for exclusive use by the user. However, in this case, there is a problem that the set value sets that have heretofore been used cannot be used.

### BRIEF SUMMARY OF THE INVENTION

According to an aspect of the present invention, there is provided an image forming apparatus for processing an input image signal based on a specific adjustment value set, thereby to output an image, comprising: an operation section which receives specific information on the adjustment value set; a display section which displays an object associated with the adjustment value set.

According to another aspect of the present invention, there is provided an image processing device comprising: an image read section which reads an image of a read object to produce a first image signal; an operation section which receives specific information on an adjustment value set for use in image processing to be applied to the first image signal; a display section which displays an object associated with the adjustment value set; a main control section which subjects the first image signal to the image processing based on the adjustment value set to produce and output a second image signal; and an image forming section which forms an image based on the second image signal.

According to further another aspect of the present invention, there is provided an image processing method comprising: subjecting an input image signal to image processing based on an adjustment value set associated with an object to be displayed to output an image; and adjusting the adjustment value set, and subsequently displaying the object.

According to another aspect of the present invention, there is provided an image forming apparatus for processing an input image signal based on a specific adjustment value set, thereby to output an image, comprising: an operation section which specific information on the adjustment value set; a display section which displays an object associated with the adjustment value set after the specific information is input to adjust the adjustment value set.

According to further another aspect of the present invention, there is provided an image processing device comprising: an image read section which reads an image of a read object to produce a first image signal; an operation section which receives specific information on an adjustment value set for use in image processing to be applied to the first image signal; a display section which displays an object associated with the adjustment value set after the specific information is input to adjust the adjustment value set; a main control section which subjects the first image signal to the image processing based on the adjustment value set to produce and output a second image signal; and an image forming section which forms an image based on the second image signal.

### BRIEF DESCRIPTION OF THE SEVERAL VIEWS OF THE DRAWING

FIG. 1 is a schematic diagram showing an example of an image forming apparatus of the present invention;

FIG. 2 is a block diagram showing a flow of signals for electric connection and control of a digital copying apparatus 1 shown in FIG. 1;

FIG. 3 is a flowchart showing an example of a setting method and an adjusting method in a user mode;

FIG. 4 is a flowchart showing an example of an operation for selecting the user mode set by the setting method and the adjusting method in the user mode shown in FIG. 3;

FIG. 5 is a schematic diagram of a screen displayed in a display section 264;

FIG. 6 is a schematic diagram of a screen displayed in the display section 264;

FIG. 7 is a schematic diagram of a screen displayed in the display section 264;

FIG. 8 is a schematic diagram of a screen displayed in the display section 264;

FIG. 9 is a flowchart showing other example of the setting method and adjusting method in the user mode;

FIG. 10 is a flowchart showing an example of an operation for selecting the user mode set by the setting method and adjusting method in the user mode shown in FIG. 9;

FIG. 11 is a flowchart showing other example of the setting method and adjusting method in the user mode;

FIG. 12 is a flowchart showing an example of an operation for selecting the user mode set by the setting method and adjusting method in the user mode shown in FIG. 11.

### DETAILED DESCRIPTION OF THE INVENTION

(First Embodiment)

A digital copying machine which is an embodiment of an image forming apparatus will be described hereinafter with reference to the drawings.

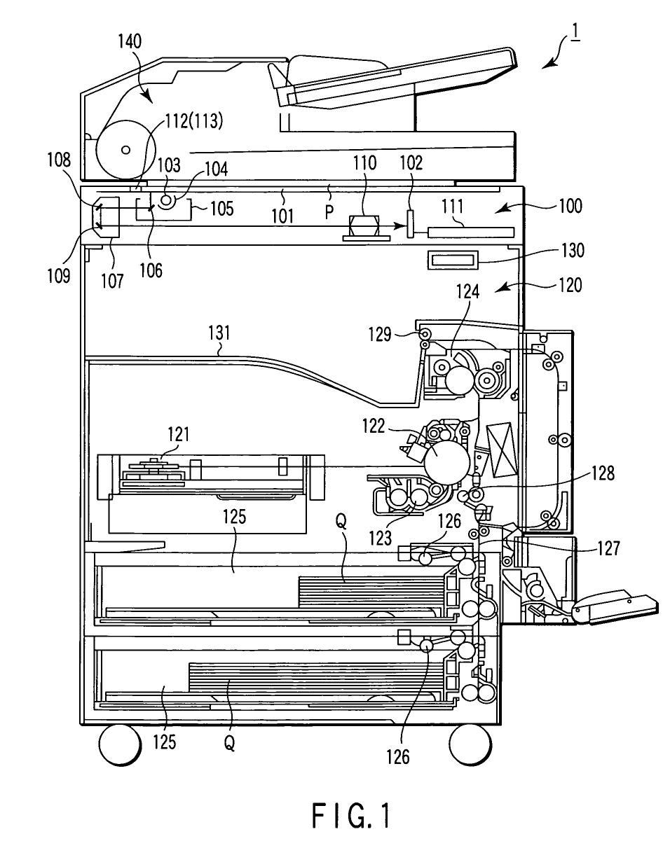

As shown in FIG. 1, a digital copying apparatus 1 comprises: a scanner (image read device) 100 which is an image reading section which reads a document image to produce a first image signal; an image forming section 120 which forms an image based on a second image signal; and an input/output section 130 for receiving/transferring information with respect to an external apparatus, storage medium or the like. In the scanner 100, an automatic document feeding device (ADF) 140 is disposed.

The scanner 100 includes a document table 101. The document table 101 holds a copying object P which is a solid material such as a book, or a sheet document.

A photoelectric conversion device (CCD sensor) 102 which converts image information of the document P into an electric signal is disposed in a predetermined position in the scanner 100 under the document table 101. The image information of the document P set on the document table 101 is transmitted to the CCD sensor 102 via a plurality of mirrors described later.

An illuminating lamp 103 which radiates light toward the document table 101, and a reflector 104 which converges the light radiated by the illuminating lamp 103 onto a predetermined position of the document table 101 are disposed in a space along the document table 101 under the document table 101. The illuminating lamp 103 and reflector 104 are moved on a rail (not shown) and fixed to a first carriage 105 reciprocating-movable along the surface of the document table 101.

In the first carriage 105, an image take-out mirror 106 is disposed to guide reflected light from the document P illuminated by illuminative light from the illuminating lamp 103 and reflector 104, that is, image information of the document P in a predetermined direction. It is to be noted that in the following description, the reflected light from the document P is referred to as image light.

A second carriage 107 moved following the first carriage 105 is disposed in the vicinity of the first carriage 105 and in a direction in which the image light from the document P captured by the image take-out mirror 106 is reflected.

In the second carriage 107, a first image mirror 108 and a second image mirror 109 which each bend the image light from the image take-out mirror 106 90° are disposed.

The image light reflected by the second image mirror 109 is guided into a lens 110, a predetermined image forming magnification is applied to the light by the lens 110, and an image is formed on the CCD sensor 102 disposed in a focal position of the lens 110.

The CCD sensor 102 is connected to an image processing section 111 to photoelectrically convert the input image light to an image signal which is an electric signal. The image processing section 111 subjects the input first image signal to predetermined image processing described later in detail to output a second image signal.

The image forming section 120 includes an exposure device 121, a photosensitive drum 122, a developing device 123, a fixing device 124 and the like.

The exposure device 121 outputs a laser beam whose light intensity is changed based on the second image signal output by the image processing section 111. In the digital copying apparatus 1, the laser beam output from the exposure device 121 is applied onto an outer peripheral surface of the photosensitive drum 122 charged to a predetermined potential beforehand.

Accordingly, an electrostatic latent image corresponding to an image to be copied is formed on a predetermined position of the photosensitive drum 122.

The electrostatic latent image (not shown) formed on the photosensitive drum 122 is converted to a toner image by the developing device 123. The toner image (not shown) formed on the surface of the photosensitive drum 122 is transferred onto a sheet Q stored in a sheet cassette 125 in a transfer position facing a transfer device which is not denoted with any reference numeral.

The sheets Q are taken from the sheet cassette 125 by a pick-up roller 126 sheet by sheet, and conveyed toward the photosensitive drum 122 along a conveyance path 127.

The sheet Q conveyed along the conveyance path 127 is once stopped by an aligning roller 128 in such a manner that a position of the toner image held by the photosensitive drum 122 on the sheet Q matches that of an image of the document P, thereafter timing is matched, and the sheet Q is guided into the transfer position in which the transfer device not described in detail herein faces the photosensitive drum 122.

Toner (not shown) of the toner image transferred onto the sheet Q is carried onto the fixing device 124, when the sheet Q is moved, and the toner image is fixed onto the sheet Q.

The sheet Q onto which the toner image (not shown), that is, a image of the copying object P or a image corresponding to image information supplied from the external apparatus is fixed is discharged to a space defined between the scanner 100 and the sheet cassette 125, that is, an image output medium holding section (tray) 131 by a discharge roller 129.

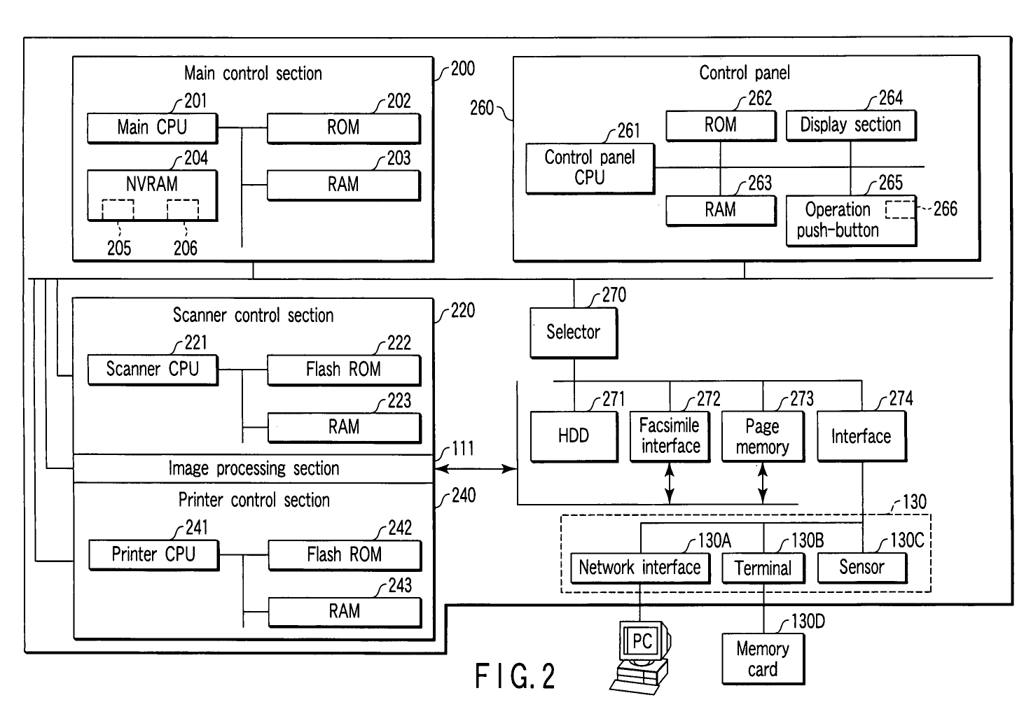

FIG. 2 shows a block diagram showing a flow of signals for electric connection and control of the digital copying apparatus 1.

As shown in FIG. 2, a main control section 200 including a main central processing unit (CPU) 201 is connected to: a scanner control section 220 including a scanner CPU 221 which controls the scanner section 100; a printer control section 240 including a printer CPU 241 which controls the image forming section (printer section) 120; the image processing section 111; a control panel 260; and a selector (bus controller) 270 via a bus line.

The selector 270 is connected to an HDD 271, a facsimile interface (facsimile transmission/reception section) 272, a page memory 273, and an interface 274 via a bus line. The image processing section 111 is connected to the facsimile transmission/reception section 272 and page memory 273 via a bus line. The interface 274 is connected to the input/output section 130, and the input/output section 130 includes, for example, a network interface 130A, a terminal 130B, and a sensor 130C. The network interface 130A is a terminal for electrically connecting the external apparatus (e.g., a personal computer) to the present digital copying apparatus 1, and is connected to internet, LAN or the like. The terminal 130B receives/transfers information with respect to predetermined storage mediums such as a memory card 130D. The sensor 130C is used, for example, in radio communication using predetermined radio waves such as infrared rays.

In the present embodiment, the second image signal is produced by subjecting the first image signal to specific image processing in the image processing section 111, but is not limited to this signal, and may also be an image signal input via the input/output section 130.

The main control section 200 includes a main CPU 201, ROM 202, RAM 203, and NVRAM 204. In the ROM 202, a program which generally controls each section of the digital copying apparatus 1, an exclusive-use program for analyzing or preparing electronic mails and the like are stored. In the RAM 203, a work area required for the main CPU 201 to perform a predetermined processing operation and the like are formed. The main CPU 201 executes the program stored in the ROM 202 to generally control each section of the digital copying apparatus 1.

The nonvolatile RAM (NVRAM) 204 is a nonvolatile memory backed up by a battery (not shown), and is capable of holding stored data even when power supply is interrupted. As described later in detail, the NVRAM 204 includes a basic storage (first storage) 205 in which a setting value set of an initial setting mode for use in a document mode as an image adjustment function is stored, and an user storage memory (second storage) 206 in which an adjusted value set of a user mode for use in the document mode is stored.

The control panel 260 includes a control panel CPU 261, flash ROM 262, RAM 263, display section 264, and operation push-button (operation section) 265. The adjustment value set is selected or adjusted by the input from the control panel 260. In the flash ROM 262, a program for controlling the display section 264 and operation push-button 265 is stored as firmware (F/W). The control panel CPU 261 executes the program stored in the flash ROM 262 by the input from the operation push-button 265 or the main CPU 201 to control the information displayed in the display section 264.

The scanner control section 220 includes the scanner CPU 221, a flash ROM 222, and a RAM 223. A program for controlling an image read operation of the scanner control section 220 is stored as firmware in the flash ROM 222. The scanner CPU 221 executes the program stored in the flash ROM 222 to operate the scanner 100. For example, as described above, the image of the document P is read, and the image data is sent to the image processing section 111. It is to be noted that for the following description, the read operation of the scanner 100 is defined as an operation in which the light from the illuminating lamp 103 is applied onto the document P, and the reflected light from the document P is input into the CCD sensor 102 and output as photoelectrically converted image data to the image processing section 111.

The image processing section 111 subjects the image data sent from the scanner control section 220, that is, the image data output from the CCD sensor 102 to the predetermined image processing. For example, the image data amplified to a predetermined threshold level and recognized as character or image information is output. The image data is output to the facsimile transmission/reception section 272 or the page memory 273. The image processing section 111 subjects, for example, the image data to image processing such as density adjustment, filtering adjustment, half tone adjustment, compression method, background density adjustment, color conversion adjustment, recognized image range adjustment, and use or stop of a smoothing function based on the adjusted value set.

The printer control section 240 includes the printer CPU 241, a flash ROM 242, and a RAM 243. In the flash ROM 242, a program for controlling an image forming operation of the printer control section 240 is stored as the firmware. The printer CPU 241 executes the program stored in the flash ROM 242 to operate the image forming section 120. For example, as described above, the image is formed on the sheet Q based on the image data of the document P read by the scanner 100. It is to be noted that for the following description, the image forming operation of the image forming section 120 is defined as an operation in which the laser beam corresponding to the image data output from the image processing section 111 is applied onto the charged photosensitive drum 122, the electrostatic latent image corresponding to the image to be copied is formed, and the toner image converted by the developing device 123 is transferred, and fixed onto the sheet Q by the fixing device 124.

The selector 270 is controlled by the main control section 200 to control transmission ends of various data. The page memory 273 includes a region in which the image data formed into the image by the image forming section 120 can be stored as the image data for a plurality of pages, and the image data, for example, the image of the document P can be converted to a predetermined rotation direction, compression method, expansion ratio, and resolution in accordance with the size of the sheet Q or the like. The facsimile transmission/reception section 272 can be connected to a phone circuit or internet via the network interface 130A.

In the HDD 271, for example, the image data read by the scanner 100 and output from the image processing section 111, electronic mails received via the network interface 130A and the like are stored. Various application software for operating the devices such as the scanner 100 and the image forming section 120 and the like are stored.

Next, a setting method and an adjusting method of a user mode in a document mode applicable to the digital copying apparatus 1 described above will be described.

It is to be noted that the document mode is defined as an image quality adjustment function of processing the image data read by the scanner 100 in accordance with the type of the document to reproduce the image of the document P which is a read object on the sheet Q with a satisfactory image quality.

Examples of the document mode includes: a standard mode capable of forming an image with a satisfactory image quality in a case where a copying object is a document including characters and photographs; a text mode capable of forming an image with a satisfactory image quality in a case where the copying object is a document including only characters; and a photograph mode capable of forming an image with a satisfactory image quality in a case where the copying object is a document including only photographs.

The standard mode, the text mode and the photograph mode are document modes prepared in the digital copying apparatus 1 beforehand, and the user can select the type of the document mode in accordance with the copying object.

In the copying object, the image is processed based on a base value set XA, when the standard mode is selected. In the copying object, the image is processed based on a base value set XB, when the text mode is selected. In the copying object, the image is processed based on a base value set XC, when the photograph mode is selected. That is, in the copying object, the image is processed based on the base value set according the selected document mode.

It is to be noted that the types of the document mode are not limited to these three types. Usable examples include: a printed photograph mode capable of forming an image with a satisfactory image quality in a case where the copying object is a photograph document by gravure printing, such as magazine and catalog; a map mode capable of forming an image with a satisfactory image quality in a case where the copying object is a document including fine figures and characters; an automatic mode in which a pattern of a document as the copying object is recognized using a predetermined recognition mechanism (not shown) to process the image based on the base value set in accordance with each document pattern and the like.

The user mode is a mode capable of setting a predetermined base value set. For example, when the user mode is set in accordance with the copying object frequently used by the user, even with the document other than the above-described documents, the image of the document P as a read object can be reproduced on the sheet Q with a satisfactory image quality.

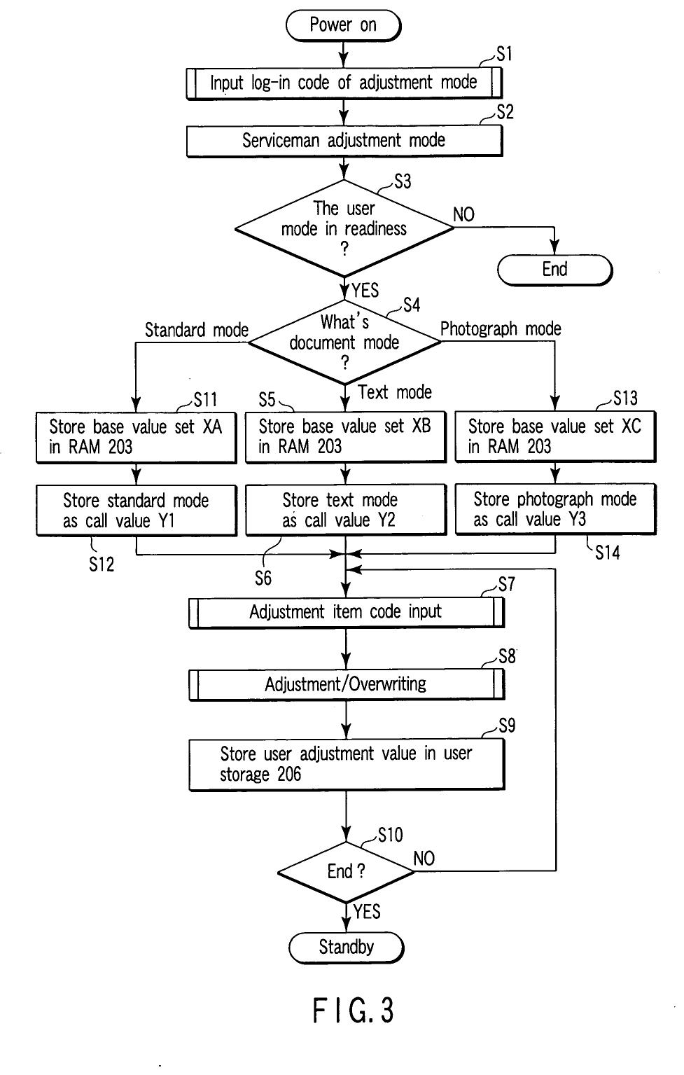

FIG. 3 is a flowchart showing an example of the setting method and the adjusting method of the user mode.

First, to set the user mode, an adjustment mode capable of adjusting the predetermined base value set of the user mode is selected. The adjustment mode is selected, when a button displayed in the display section 264 or a predetermined switch disposed on the operation push-button 265 is pressed immediately after turning on the power of the digital copying apparatus 1. Accordingly, a log-in code of the adjustment mode is input (S1).

It is to be noted that the method of selecting the adjustment mode is not limited to this method. For example, while pressing the switch or button disposed in the display section 264 or the operation push-button 265, the power of the digital copying apparatus 1 may be turned in.

When the adjustment mode is selected, the digital copying apparatus 1 is brought into a state capable of adjusting the user mode. For example, a serviceman adjustment mode state is set in which the operation by a serviceman or the like is possible (S2).

A predetermined number, for example, code number “1000” is input by a number input key (hereinafter referred to as number keys) 266 of the operation push-button 265. When the code number “1000” is input, the user mode defined as the code number “1000” is selected by the main CPU 201 (S3-YES).

It is to be noted that even with the input of the code number “1000”, when preparations for setting the user mode are insufficient, it is judged that a menu function for setting the user mode is not effective, and the process is ended (S3-NO).

When the user mode is selected, any of the standard mode, the text mode and the photograph mode is selected as a basic setting mode from the document modes by a predetermined selection key of the number keys 266 or the display section 264 (S4).

For example, the base value set XB of the selected basic setting mode, the text mode is called from the first storage (basic storage) 205 of the NVRAM 204 by the main CPU 201, and stored as the adjustment value set of the user mode in the RAM 203 (S5).

The type of the document mode set as the basic setting mode in step S4, the text mode herein is stored as a call value Y2 of the user mode in the user storage 206 (S6). In other word, the call value Y2 is information for calling the base value set XB of the text mode. At this time, the adjustment value set stored in the RAM 203 in step S5 indicates data equal to the base value set XB of the text mode.

An adjustment item to be adjusted to a value different from that of the base value set XB of the text mode is called by the input of an adjustment item code. That is, by the input of a predetermined number from the number keys 266, for example, code number “1100”, a predetermined adjustment item defined as the code number “1100” is called and selected by the main CPU 201 (S7).

By the input of the adjustment item code, the adjustable value of the selected adjustment item is called from the RAM 203 and displayed in the display section 264. At this time, the adjustable value is the same data as that of the data included in the base value set XB of the text mode. When a desired adjustment value is input, the adjustable value stored in the RAM 203 is changed to the adjusted value Xd (S8).

At this time, the adjusted value stored in the RAM 203 is included in the adjusted adjustment item; the any adjusted adjustment items and any not-adjusted adjustment items are included in a user adjusted value set XD.

The adjusted value of the adjusted adjustment item in the user adjusted value set XD, that is, only a user adjusted value Xd is stored in the user storage 206 of the NVRAM 204 (S9).

Moreover, the call value is associated with not the data of the base value sets XA-XC, but the base value sets XA-XC stored in the basic storage 205, that is, the basic setting mode selected in step S4. Later, the main CPU 201 reads the base value set XB of the document mode, i.e., text mode stored in the basic storage 205 based on the call value stored in the user storage 206.

It is selected whether or not to end the adjustment/change of the adjustable value of the adjustment item to be adjusted in the display section 264 or the operation push-button 265 (S10).

When it is selected that the adjustment/change is not ended, the process returns to step S7, and the above-described adjustment/change is possible. When it is instructed to end the adjustment/change, for example, a usual copying operation is possible in the state (standby). Instructing to end the adjustment/change the adjusted value is selected in the screen, or being used in which the power of the apparatus is turned on again after ending the input of a necessary adjusted value code number and adjusted value.

It is to be noted that when the user mode is already set, that is, in second and subsequent user mode setting, steps S1 to S3 are executed in the same manner, and the adjustment mode shifts to a state capable of setting the user mode. When the standard mode is selected as the basic setting mode in step S4, the base value set XA of the standard mode is called from the basic storage 205, and stored as the adjustment value set of the user mode in the RAM 203 (S1). And the standard mode set as the basic setting mode in the step S4 is stored as the call value Y1 of the user mode in the user storage 206 (S12). In other word, the call value Y1 is an information for calling the base value set XA of the standard mode.

The adjustable value of the adjustment item to be adjusted can be adjusted/changed as described above in the steps S7 to S10.

By the input of the adjustment item code (S7), the adjustable value of the selected adjustment item is called from the RAM 203 and displayed in the display section 264, and a desired adjustment value is input (S8).

When the adjustable value of the adjustment item to be adjusted is adjusted/changed to a user adjusted value Xe, the user adjusted value Xd stored in the user storage 206 is deleted, and the user adjusted value Xe is stored in the user storage 206 (S9). In other words, the user storage 206 is overwritten of the user adjusted value Xd with the user adjusted value Xe.

Moreover, also when the photograph mode is selected as the basic setting mode in step S4, the base value set XC of the photograph mode is similarly called from the basic storage 205, and stored as the adjustment value set of the user mode in the RAM 203 (S13). And the photograph mode set as the basic setting mode in step S4 is stored as the call value Y3 of the user mode in the user storage 206 (S14).

The adjustable value of the adjustment item to be adjusted can be adjusted/changed as described above in steps S7 to S10.

By the input of the adjustment item code (S7), the adjustable value of the selected adjustment item is called from the RAM 203 and displayed in the display section 264, and a desired adjustment value is input (S8).

When the adjustable value of the adjustment item to be adjusted is adjusted/changed to a user adjusted value Xf, the user adjusted value Xe stored in the user storage 206 is deleted, the user adjusted value Xf is stored in the user storage 206 (S9). In other words, the user storage 206 is overwritten of the user adjusted value Xe with the user adjusted value Xf.

Concretely, for example, when the document P as the copying object is a document having a high background density (e.g., newspapers, or color paper on which the characters are written), and the image is formed in a usual text mode or the like, the image of the sheet Q entirely becomes black, and there is a problem that information formed on the document P is not easily seen. Therefore, it is preferable that the image data concerning color is not formed into the image on the sheet Q in the image data of the document P read by the scanner 100.

In this case, there are two adjustment items to be required in the present embodiment, including: an adjustment item as density adjustment item for adjusting the density in converting the image data of the document P read by the scanner 100 to the toner image formed on the photosensitive body 122; and an adjustment item in which the background density of the document P is recognized beforehand, and the image is formed in accordance with the background density. Therefore, although there are a large number of adjustable items, a range capable of holding two adjustment items to be adjusted is sufficient in the user storage 206, and therefore a storage region (storage capacity) to store the user adjusted value is deleted.

Moreover, the information of the user adjusted values Xd, Xe and Xf may be stored as a difference from the base value set of the predetermined mode called from the basic storage 205 based on the adjustment in step S8 in the user storage 206. Therefore, the storage capacity of the user storage 206 may further be reduced.

Needless to say, the user adjusted values stored in the user storage 206 are not limited to the adjusted value Xd changed as described above, and simply the whole user adjusted value set XD may also be stored.

It is to be noted that when the document P as the copying object is a document, for example, including characters written with a pencil and having a low density, it is requested that the density of faint characters be dense and clear characters be output onto the sheet Q. In this case, to clarify the color of the character formed in the document P and the color of the document P itself, the adjustment item to change/adjust strength of a filter or the like for image signal processing, and additionally the above-described density adjustment item are required.

Moreover, in a case where the document P which is the copying object is a scrap document formed by attaching a document having a dense background such as newspaper to a document having a light background such as a blank sheet, it is requested that the image data of the color of the background of the newspaper should not be output onto the sheet Q, and the above-described density adjustment item or the like is adjusted.

When the predetermined adjustment value is input to set the user mode in this manner, a button that is an object for selecting the user mode is displayed in a selection screen of the document mode in the display section 264.

That is, to avoid user's unnecessary confusion before the user mode is set, the mode is distinguished from the standard, text, and photograph modes prepared beforehand, and the user mode button is not displayed. Alternatively, the user mode button may be displayed less visible than the buttons that may be used. In this case, the user mode button can be well distinguished from the other buttons.

In the embodiment described above, the user mode button 604 is assigned to one mode only. Nonetheless, the user mode button 604 may be assigned to various user modes. Then, when the user touches the user mode button 604, several user mode buttons are displayed on the display section 264.

Next, an example of an operation for the user to select the user mode set by the above-described setting and adjusting methods at a document copying time will be described.

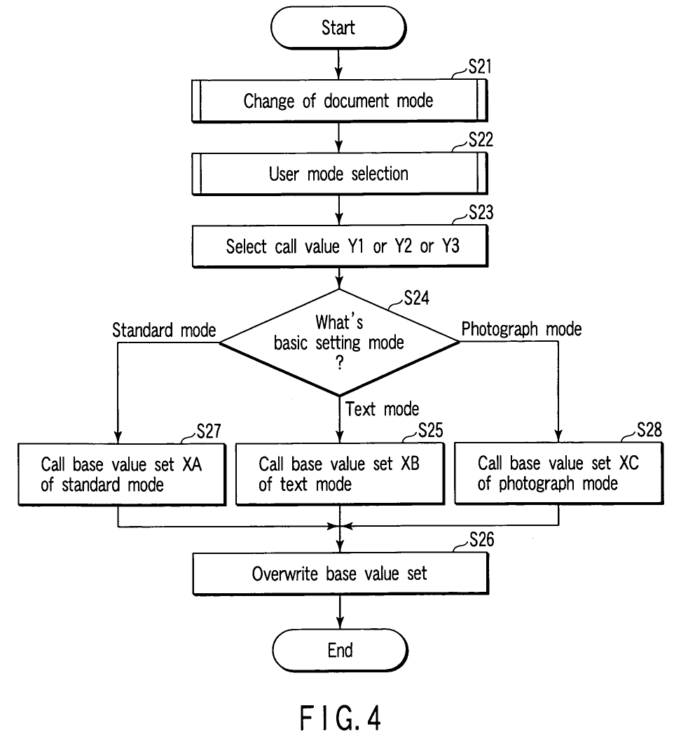

FIG. 4 is a flowchart showing an example of an operation for selecting the user mode set by the above-described method in FIG. 3.

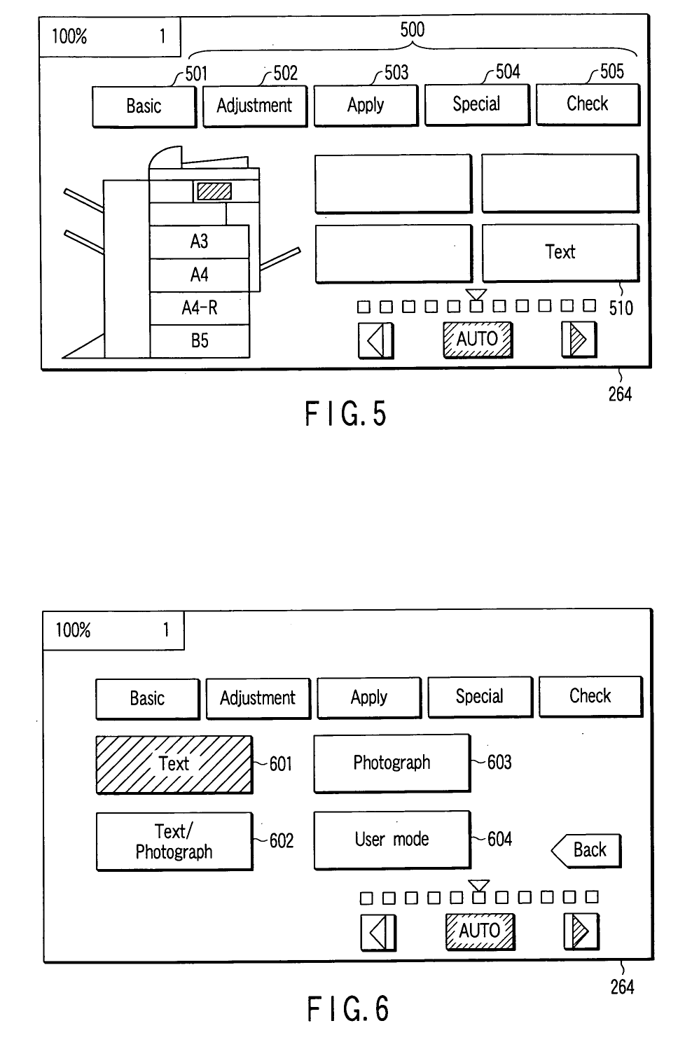

A screen shown in FIG. 5 is displayed in the display section 264 of the digital copying apparatus 1. In an upper part of the display section 264, index buttons 500 are displayed including five buttons of a “basic” button 501, an “image quality adjustment” button 502, an “apply” button 503, a “special” button 504, and a “check” button 505.

On a right part below the index buttons 500, four function setting buttons are displayed, including a document mode setting button 510. In the present embodiment, “text” is displayed in the document mode setting button 510. Instead “text/photograph” or “photograph” may be displayed in the button 510.

When the document mode setting button 510 is pressed, as shown in FIG. 6, a document mode setting button capable of selecting the type of the document mode (“text” 601, “text/photograph” 602, “photograph” 603, “user mode” 604) is displayed in a screen (S21). In this case, the color of the “text” 601 selected as the document mode is reversed. Since the user mode is already set, the display section 264 is capable of displaying the “user mode” 604. If the user mode isn't set yet, the display section 264 isn't capable of displaying the “user mode” 604.

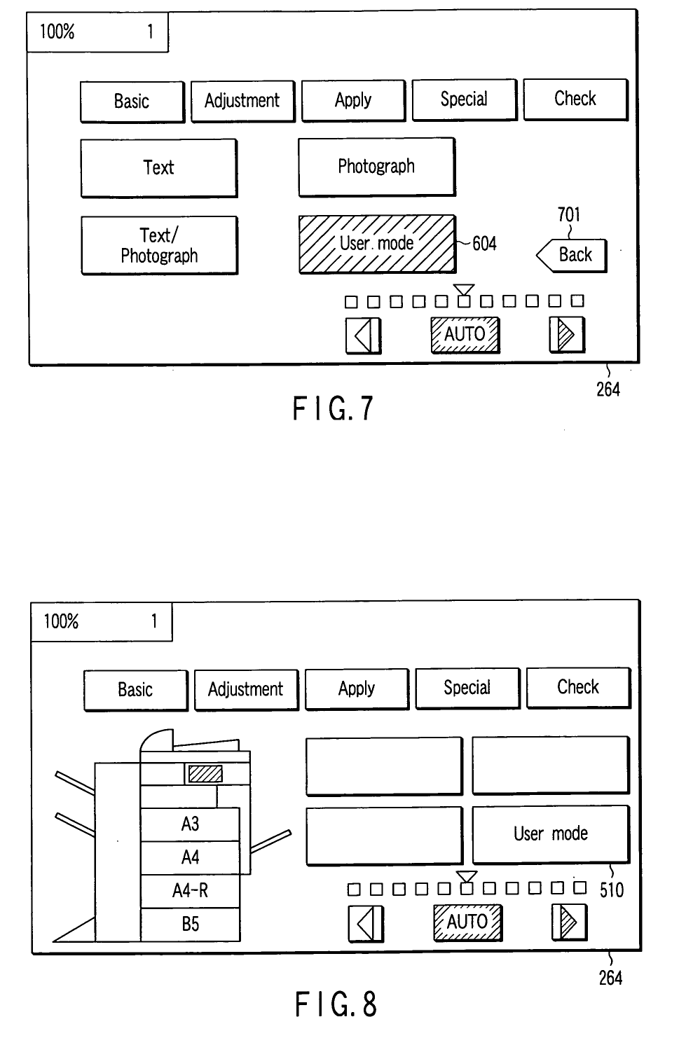

The user presses the “user mode” 604 (S22). In this case, as shown in FIG. 7, the document mode setting button capable of selecting the type of the document mode is displayed in the screen, and the color of the “user mode” 604 is reversed. Additionally, when a “back” 701 is pressed, as shown in FIG. 8, a screen capable of selecting a function setting button included in the “basic” button 501 in the index buttons 500 is displayed, and the set “user mode” is displayed as the document mode setting button.

When the user presses the “user mode” 604 in step S22, and the call value Y1, Y2 or Y3 is selected. The CPU 201 reads the selected call value of the user mode stored in the user storage 206 of the NVRAM 204 (S23).

The text mode is selected as the basic setting mode of the user mode based on the read call value Y2 (S24).

The base value set XB of the text mode is called from the first storage (basic storage) 205 of the NVRAM 204 and stored in the RAM 203 by the main CPU 201 (S25).

When the user adjusted value Xd is called from the second storage (user storage) 206 of the NVRAM 204, the base value set XB stored in the RAM 203 is overwritten of an adjustment item corresponding to the user adjusted value Xd with the user adjusted value Xd.(S26). In other word, the user adjusted value Xd replace the same adjustment item included of the base value set XB in the RAM 203. So the base value set XB in the RAM 203 includes the user adjusted value Xd and data of any not-adjusted adjustment items.

It is to be noted that when the user mode call value Y1 is set, and the standard mode is selected as the basic setting mode of the user mode in the step S23, the base value set XA of the photograph mode is called from the basic storage 205 and stored in the RAM 203 (S27).

The user adjusted value Xe is called from the user storage 206, the base value set XA stored in the RAM 203 is overwritten of an adjustment item corresponding to the user adjusted value Xe with the user adjusted value Xe (S26). In other word, the user adjusted value Xe replace the same adjustment item included of the base value set XA in the RAM 203. So the base value set XA in the RAM 203 includes the user adjusted value Xe and data of any not-adjusted adjustment items. Moreover, when the call value Y3 is similarly set, and the photograph mode is selected as the basic setting mode of the user mode in the S23, the base value set XC of the photograph mode is called from the basic storage 205 and stored in the RAM 203 (S28).

The user adjusted value Xf is called from the user storage 206, the base value set XC stored in the RAM 203 is overwritten of an adjustment item corresponding to the user adjusted value Xf with the user adjusted value Xf (S26). In other word, the user adjusted value Xf replace the same adjustment item included of the base value set XC in the RAM 203. So the base value set XC in the RAM 203 includes the user adjusted value Xf and data of any not-adjusted adjustment items.

Assume that the user frequently selects the standard mode, text mode or photograph mode. Then, one of these modes may be assigned to the user mode button 604. Thus, one of these modes can be selected when the user touches the user mode button 604.

(Second Embodiment)

Next, methods different from the setting and adjusting methods of the user mode shown in FIGS. 3, 4 will be described.

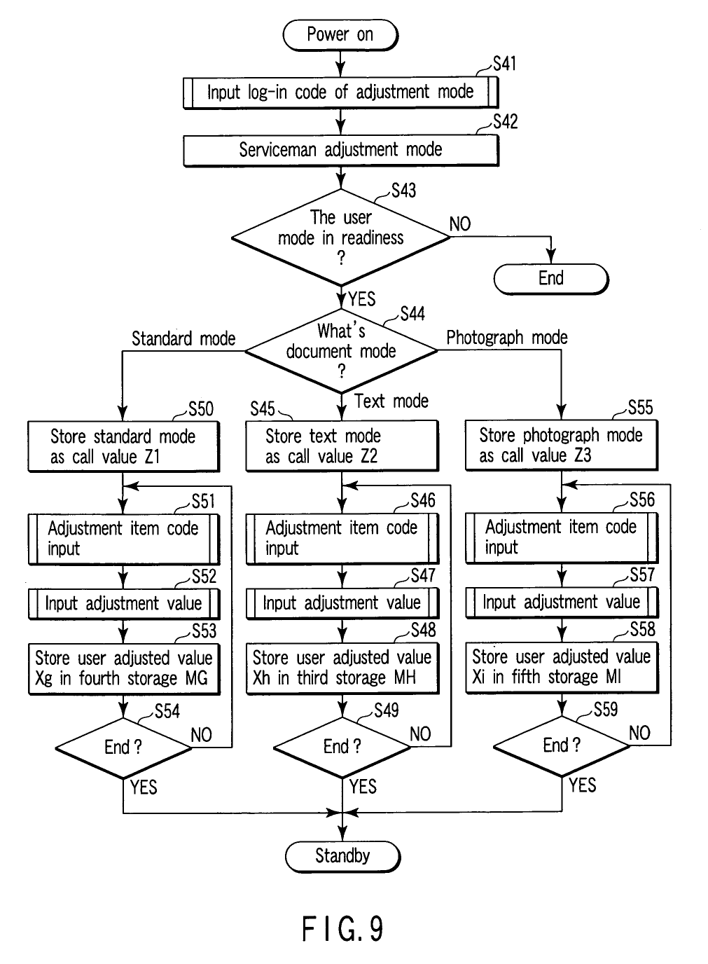

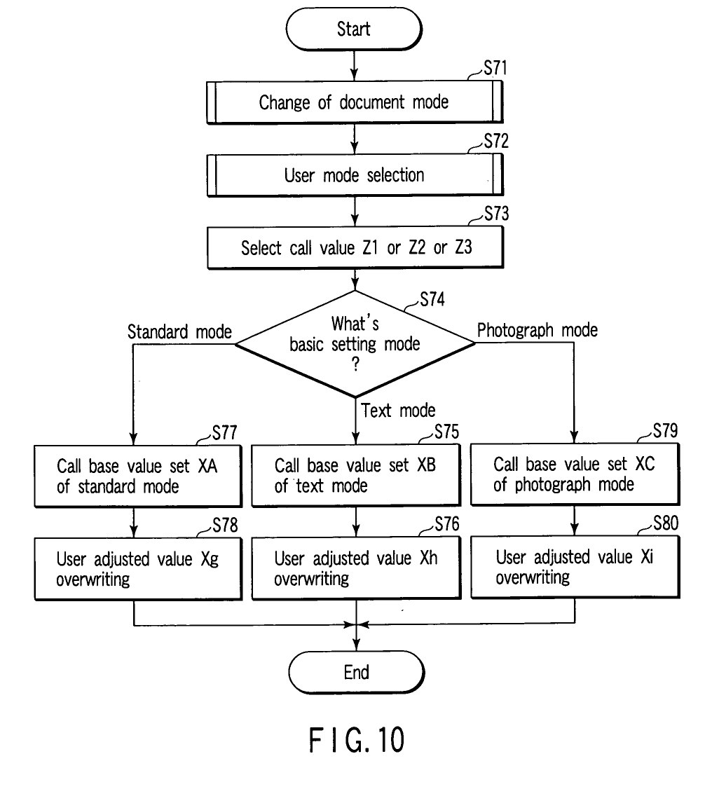

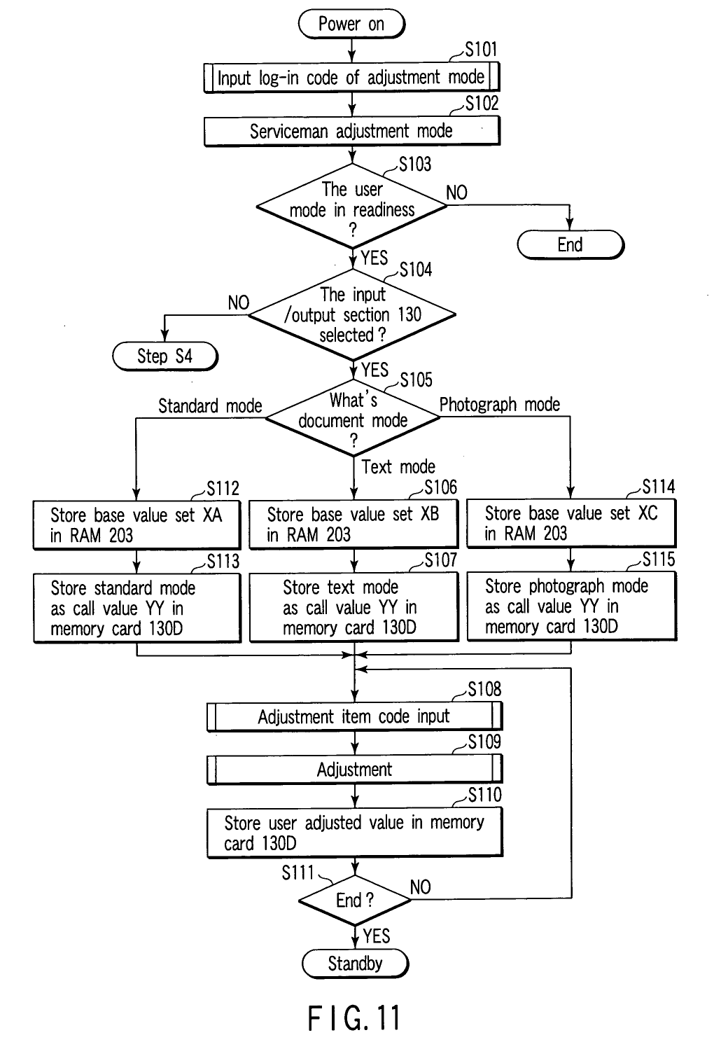

As shown in FIG. 9, for example, immediately after the power of the digital copying apparatus 1 is turned ON, the switch or button of the display section 264 or the operation push-button 265 is pressed, and accordingly a log-in code of an adjustment mode is input (S41).

The digital copying apparatus 1 is brought into a serviceman adjustment mode state in which the operation by the serviceman is possible (S42).

When a predetermined number, for example, a code number “1000” is input by the number keys 266, the user mode defined as the code number “1000” is selected by the main CPU 201 (S43-YES). Even with the input of the code number “1000”, when preparations for setting the user mode are insufficient, it is judged that the menu function for setting the user mode is not effective to end the process (S43-NO).

When the user mode is selected, any of the standard mode, the text mode and the photograph mode are selected as the basic setting mode from the document modes (S44).

When the text mode is selected as the basic setting mode, a call value Z2 for calling the text mode is stored in the user storage 206 (S45).

Next, a code number “1100” which is an adjustment item code is input (S46).

The main CPU 201 calls the adjustment item defined as the code number “1100”, and displays the adjustable value of the selected adjustment item in the display section 264. An adjustable value to be adjusted is input, and changed to a user adjusted value Xh (S47).

The user adjusted value Xh is stored in a third storage MH in the second storage (user storage) 206 of the NVRAM 204 by the main CPU 201 (S48).

It is selected whether or not to end the adjustment/change of the adjustable value of the adjustment item to be adjusted in the display section 264 or the operation push-button 265 (S49). When it is selected that the adjustment/change is not ended, step S46 is performed again (S49-No). When it is instructed to end the adjustment/change (S49-Yes), a usual copying operation is possible in the state.

Moreover, the selection of the end of the adjustment is not displayed, and the code number is continued to be input to continue the adjustment value input, the main apparatus power may be turned on again to end the adjustment. Moreover, a system for preparing the number of adjustment item codes, adjustable by user without serviceman beforehand in the user mode, or a system for storing only the code to be adjusted may also be used.

It is to be noted that when the user mode is already set, and when the standard mode is similarly selected as the basic setting mode in a state capable of setting the user mode shifted from the adjustment mode in step S44, a call value Z1 for calling the standard mode is stored in the user storage 206 (S50).

Moreover, the adjustment item code of the adjustment item to be adjusted is input (S51).

When an adjustable value of the adjustment item to be adjusted is adjusted/changed to a user adjusted value Xg (S52), the user adjusted value Xg is stored in a fourth storage MG of the second storage (user storage) 206 of the NVRAM 204 by the main CPU 201 (S53).

It is selected whether or not to end the adjustment/change of the adjustable value of the adjustment item to be adjusted in the display section 264 or the operation push-button 265 (S54). When it is selected that the adjustment/change is not ended, the step S51 is performed again.

Moreover, also when the photograph mode is selected as the basic setting mode in step S44, a call value Z3 for calling the photograph mode is similarly stored in the user storage 206 (S55).

Furthermore, the adjustment item code of the adjustment item to be adjusted is input (S56).

When an adjustable value of the adjustment item to be adjusted is adjusted/changed to a user adjusted value Xi (S57), the user adjusted value Xi is stored in a fifth storage MI of the second storage (user storage) 206 of the NVRAM 204 by the main CPU 201 (S58).

It is selected whether or not to end the adjustment/change of the adjustable value of the adjustment item to be adjusted in the display section 264 or the operation push-button 265 (S59). When it is selected that the adjustment/change is not ended, step S56 is performed again.

The storage in which the adjusted value of the user mode is stored is independently formed in accordance with the types of the document modes prepared beforehand, that is, the standard mode, the text mode and the photograph mode herein, and accordingly a system is easily constructed.

Moreover, as described in the example shown in FIGS. 3 and 4, the region capable of holding the required adjustment item is sufficient as the storage-in which the user adjusted value is stored, and therefore the storage capacity is deleted.

Next, an example of the operation for the user to select the user mode set by the above-described setting and adjusting methods at a document copying time will be described.

The screen shown in FIG. 5 is displayed in the display section 264 of the digital copying apparatus 1. When the document mode setting button 510 is pressed, as shown in FIG. 6, a document mode setting button capable of selecting the type of the document mode (“text” 601, “text/photograph” 602, “photograph” 603, “user mode” 604) is displayed in a screen (S71). In this case, the color of the “text” 601 selected as the document mode is reversed. The “text” (document mode setting button) 510 is selected from the function setting buttons, and displayed in the screen shown in FIG. 6.

The user presses the “user mode” 604 (S72).

When the user presses the “user mode” 604, and the call value Z1, Z2 or Z3 is selected. The CPU 201 reads the selected call value of the user mode in the user storage 206 of the NVRAM 204 (S73).

When the call value Z2 is information for calling text mode, the text mode is selected as the basic setting mode of the user mode (S74).

The base value set XB of the text mode is called from the first storage (basic storage) 205 of the NVRAM 204 and stored in the RAM 203 by the main CPU 201 (S75).

When the user adjusted value Xh is called from the third storage MH in the second storage (user storage) 206 of the NVRAM 204, the same adjustment item with the user adjusted value Xh is overwritten in the base value set XB of the text mode stored beforehand in the RAM 203 (S76).

In step S73, it is to be noted that when the call value Z1 for calling standard mode is set, and the standard mode is selected as the basic setting mode of the user mode, the base value set XA of the standard mode is called from the basic storage 205 and stored as a basic portion of the user mode in the RAM 203 (S77).

The user adjusted value XG is called from the fourth storage region MG in the user storage 206. The same adjustment item with the user adjusted value Xg in the base value set XA stored in the RAM 203 is overwritten with the user adjusted value Xg (S78).

Moreover, in step S73, when the call value Z3 for calling the photograph mode is similarly set, and the photograph mode is selected as the basic setting mode of the user mode, the base value set XC of the photograph mode is called from the basic storage 205 and stored in the RAM 203 (S79).

A user adjusted value Xi is called from the fifth storage MI in the user storage 206. The same adjustment item with the user adjusted value Xi in the base value set XC of the photograph mode stored beforehand in the RAM 203 is overwritten with the user adjusted value Xi (S80).

Since only the user adjusted values Xg-Xi are stored in the third storage MG, the fourth storage MH and the fifth storage MI respectively , the adjusted value stored in the storages MG-MI and used before is reusable, and the trouble of inputting new data can be saved.

It is to be noted that the scanner control section 220 may change, for example, sensitivity or sampling time of the CCD sensor 102, moving speed of the first carriage 105 or the second carriage 107 and the like based on the adjusted value set. The printer control section 240 may change, for example, a charging, developing, or transferring bias, a laser beam intensity and the like based on the adjusted value set. Additionally, these adjustments are very difficult, and correct adjustment is sometimes impossible even by the serviceman, and even a serviceman mode for safety may be constituted to be non-adjustable.

It is to be noted that in the above-described embodiment, the user mode is set in the serviceman mode, but the user may also set the mode at the user's responsibility. In this case, the input of the code number is not easily seen for the user. For example, the button associated with each code number may be displayed in the display section 264, and characters such as “density adjustment” and “filtering” or pictures indicating them may also be displayed on each button. When these buttons are pressed, the same operation as that performed when each code number is input may be performed.

It is to be noted that in the above-described embodiment, the image processing section 111 mounted on the digital copying apparatus 1 performs various adjustments based on the adjusted value set, but various adjustments may also be performed with respect to the image data in image processing sections optionally attached to the image forming apparatus, such as an external controller unit, based on the adjusted value set.

It is to be noted that the button is used as the object in the embodiment, but, for example, a character string or any picture may also be used as the object.

As described above, in the image forming apparatus of the present invention, the information of the adjusted value of the user mode is added to the information of the base value set, and accordingly required image quality adjustment of the copying object can be performed. Therefore, since data of the base value set XA-XC of the standard mode, the text mode and the photograph mode are not changed, the user mode is usable, and the standard mode, the text mode and the photograph mode may also be used.

(Third Embodiment)

Next, methods different from the setting and adjusting methods of the user mode shown in FIGS. 3, 4 will be described.

FIG. 11 is a flowchart showing an example of the setting method and the adjusting method of the user mode in the case using the input/output section 130. In this case, the terminal 130B the input/output section 130 connected to memory card 130D.

First, to set the user mode, an adjustment mode capable of adjusting the predetermined base value set of the user mode is selected. A log-in code of the adjustment mode is input (S101), a serviceman adjustment mode state is set (S102).

When the code number “1000” is input, the user mode defined as the code number “1000” is selected by the main CPU 201 (S103-YES). On the other hand, it is judged that a menu function for setting the user mode is not effective, and the process is ended (S103-NO).

When the user mode is selected, the storage for storing a user adjusted value adjusted by present adjusting method is selected in which the input/output section 130 or the user storage 206 in NVRAM 204 (S104). When the user storage 206 is selected, the user adjusted value is stored in the user storage 206 according to the above-mentioned adjusting method in FIG. 3 and 4 (S105).

When the input/output section 130 is selected, any of the standard mode, the text mode and the photograph mode is selected as a basic setting mode from the document modes by a predetermined selection key of the number keys 266 or the display section 264 (S105).

For example, the base value set XB of the selected basic setting mode, the text mode is called from the basic storage 205 of the NVRAM 204 by the main CPU 201, and stored as the adjustment value set of the user mode in the RAM 203 (S106).

The type of the document mode set as the basic setting mode in step S105, the text mode is stored as a call value YY of the user mode in memory card 130D (S107). In other word, the call value YY is information for calling the base value set XB of the text mode.

By the input of a predetermined number from the number keys 266, for example, code number “1100”, a predetermined adjustment item defined as the code number “1100” is called and selected by the main CPU 201 (S108).

By the input of the adjustment item code, the adjustable value of the selected adjustment item is called from the RAM 203 and displayed in the display section 264. When a desired adjustment value is input, the adjustable value stored in the RAM 203 is changed to the adjusted value Xd (S109).

The adjusted value of the adjusted adjustment item , that is, only a user adjusted value Xd is stored in the memory card 130D (S110).

Moreover, the call value YY is associated with not the data of the base value sets XA-XC, but the base value sets XA-XC stored in the basic storage 205, that is, the basic setting mode selected in step S105. Later, the main CPU 201 reads the base value set XB of the document mode, i.e., text mode stored in the basic storage 205 based on the call value YY stored in the memory card 130D.

It is selected whether or not to end the adjustment/change of the adjustable value of the adjustment item to be adjusted in the display section 264 or the operation push-button 265 (S111).

When it is selected that the adjustment/change is not ended, the process returns to step S108, and the above-described adjustment/change is possible. When it is instructed to end the adjustment/change, for example, a usual copying operation is possible in the state (standby).

When the standard mode is selected as the basic setting mode in step S105, the base value set XA of the standard mode is called from the basic storage 205, and stored as the adjustment value set of the user mode in the RAM 203 (S112). And the standard mode set as the basic setting mode is stored as the call value YY of the user mode in the memory card 130D (S113). In other word, the call value YY is information for calling the base value set XA of the standard mode.

By the input of the adjustment item code (S108), the adjustable value of the selected adjustment item is called from the RAM 203 and displayed in the display section 264, and a desired adjustment value is input (S109).

When the adjustable value of the adjustment item to be adjusted is adjusted/changed to a user adjusted value Xe, and the user adjusted value Xe is stored in the memory card 130D(S110). Moreover, also when the photograph mode is selected as the basic setting mode in step S105, the base value set XC of the photograph mode is similarly called from the basic storage 205, and stored as the adjustment value set of the user mode in the RAM 203 (S114). And the photograph mode set as the basic setting mode is stored as the call value YY of the user mode in the memory card 130D (S115).

By the input of the adjustment item code (S108), the adjustable value of the selected adjustment item is called from the RAM 203 and displayed in the display section 264, and a desired adjustment value is input (S109).

When the adjustable value of the adjustment item to be adjusted is adjusted/changed to a user adjusted value Xf, the user adjusted value Xf is stored in the memory card 130D (S110). Accordingly the user adjust value stored in memory card 130D is portable to many other digital copying apparatus. So it is possible to use the same user adjusted value with many different digital copying apparatus by many user. Moreover once the user adjusted value is stored in the memory card 130D, the user can use the user adjusted value any number of times, when using the same adjusted value it is not necessary to adjust by serviceman.

Next, an example of an operation for the user to select the user mode set by the above-described setting and adjusting methods at a document copying time will be described.

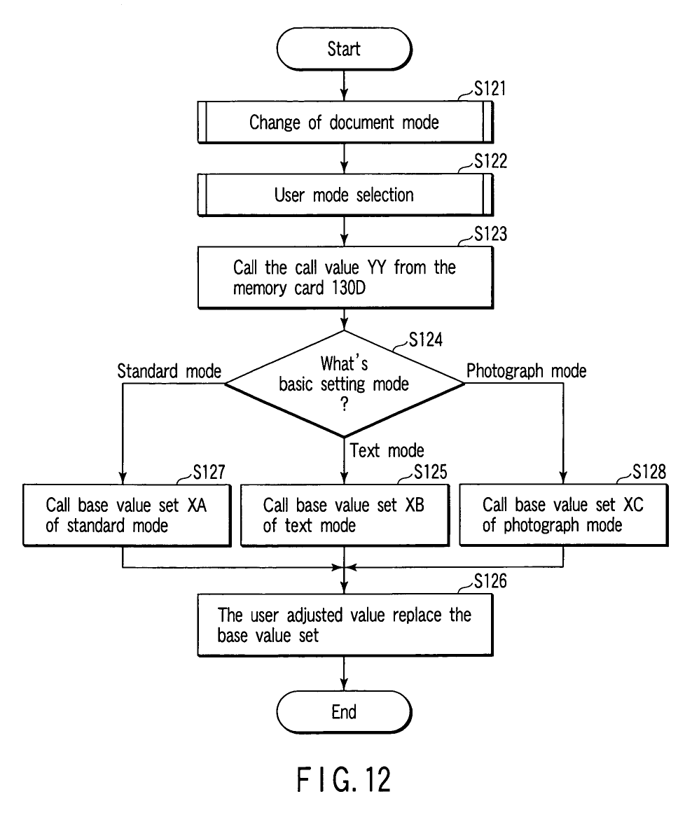

FIG. 12 is a flowchart showing an example of an operation for selecting the user mode set by the above-described method in FIG. 11.

In FIG. 5, when the document mode setting button 510 is pressed, as shown in FIG. 6, a document mode setting button capable of selecting the type of the document mode is displayed in a screen (S121). In this case, the color of the “text” 601 selected as the document mode is reversed. Since the user mode is already set, the display section 264 is capable of displaying the “user mode” 604.

The user presses the “user mode” 604 (S122). In this case, as shown in FIG. 7, the document mode setting button capable of selecting the type of the document mode is displayed in the screen, and the color of the “user mode” 604 is reversed. Additionally, when a “back” 701 is pressed, as shown in FIG. 8, a screen capable of selecting a function setting button included in the “basic” button 501 in the index buttons 500 is displayed, and the set “user mode” is displayed as the document mode setting button.

When the user presses the “user mode” 604 in step S122, the CPU 201 reads the call value YY of the user mode stored in the memory card 130D (S123).

The text mode is selected as the basic setting mode of the user mode based on the read call value YY (S124).

The base value set XB of the text mode is called from the basic storage 205 of the NVRAM 204 and stored in the RAM 203 by the main CPU 201 (S125).

When the user adjusted value Xd is called from the memory card 130D, the base value set XB stored in the RAM 203 is overwritten of an adjustment item corresponding to the user adjusted value Xd with the user adjusted value Xd (S126). In other word, the user adjusted value Xd replace the same adjustment item included of the base value set XB in the RAM 203. So the base value set XB in the RAM 203 includes the user adjusted value Xd and data of any not-adjusted adjustment items.

It is to be noted that when the user mode call value YY called from the memory card 130D is set, and the standard mode is selected as the basic setting mode of the user mode in the step S123, the base value set XA of the photograph mode is called from the basic storage 205 and stored in the RAM 203 (S127).

The user adjusted value Xe is called from the memory card 130D, the base value set XA stored in the RAM 203 is overwritten of an adjustment item corresponding to the user adjusted value Xe with the user adjusted value Xe (S126). In other word, the user adjusted value Xe replace the same adjustment item included of the base value set XA in the RAM 203. So the base value set XA in the RAM 203 includes the user adjusted value Xe and data of any not-adjusted adjustment items.

Moreover, when the call value YY called from the memory card 130D is similarly set, and the photograph mode is selected as the basic setting mode of the user mode in the S123, the base value set XC of the photograph mode is called from the basic storage 205 and stored in the RAM 203 (S128).

The user adjusted value Xf is called from the memory card 130D, the base value set XC stored in the RAM 203 is overwritten of an adjustment item corresponding to the user adjusted value Xf with the user adjusted value Xf (S126). In other word, the user adjusted value Xf replace the same adjustment item included of the base value set XC in the RAM 203. So the base value set XC in the RAM 203 includes the user adjusted value Xf and data of any not-adjusted adjustment items.

In the embodiment it is possible to use the user adjusted storage 206 as storage stored the user adjusted value Xd-Xf for the time being. The user adjusted value Xd-Xf stored in the user adjusted storage 206 is sent to network interface 130A or sensor 130C, and is output outside. At this time, nothing is stored in the user adjusted storage 206.

While connecting the memory card 130D with terminal, the display section 264 display the document mode setting button 510. And non-connecting the memory card 130D with terminal, the display section 264 does not display the document mode setting button 510.

1. An image forming apparatus for processing an input image signal based on a specific adjustment value set, thereby to output an image, comprising:
an operation section which receives specific information on the adjustment value set;
a display section which displays an object associated with the adjustment value set.

2. The image forming apparatus according to claim 1, further comprising:
an image read section which reads an image of a read object to produce a first image signal,
wherein the specific information on the adjustment value set for use in the image processing to be applied to the first image signal is input in the operation section, and
the image forming section subjects the first image signal to the image processing based on the adjusted adjustment value set to produce a second image signal, and forms an image based on the second image signal.

3. The image forming apparatus according to claim 1, wherein the adjustment value set includes at least one of density adjustment, filtering adjustment, half-tone adjustment, compression method, background density adjustment, color conversion adjustment, recognized image range adjustment, and enabling/disabling of a smoothing function.

4. The image forming apparatus according to claim 2, wherein the adjustment value set includes at least one of density adjustment, filtering adjustment, half tone adjustment, compression method, background density adjustment, color conversion adjustment, recognized image range adjustment, and enabling/disabling of a smoothing function.

5. The image forming apparatus according to claim 1, wherein the adjustment value set is adjusted in a serviceman adjustment mode for adjusted by serviceman.

6. The image forming apparatus according to claim 2, wherein the adjustment value set is adjusted in a serviceman adjustment mode for adjusted by serviceman.

7. The image forming apparatus according to claim 1, further comprising:
an output section which outputs the specific information on the adjusted adjustment value set to the outside.

8. The image forming apparatus according to claim 2, further comprising:
an output section which outputs the specific information on the adjusted adjustment value set to the outside.

9. An image processing device comprising:
an image read section which reads an image of a read object to produce a first image signal;
an operation section which receives specific information on an adjustment value set for use in image processing to be applied to the first image signal;
a display section which displays an object associated with the adjustment value set;
a main control section which subjects the first image signal to the image processing based on the adjustment value set to produce and output a second image signal; and
an image forming section which forms an image based on the second image signal.

10. The image processing device according to claim 9, wherein the adjustment value set includes at least one of density adjustment, filtering adjustment, half-tone adjustment, compression method, background density adjustment, color conversion adjustment, recognized image range adjustment, and enabling/disabling of a smoothing function.

11. The image processing device according to claim 9, wherein the adjustment value set is adjusted in a serviceman adjustment mode for adjusted by serviceman.

12. The image processing device according to claim 9, further comprising:
an output section which outputs the specific information on the adjusted adjustment value set to the outside.

13. An image processing method comprising:
subjecting an input image signal to image processing based on an adjustment value set associated with an object to be displayed to output an image; and
adjusting the adjustment value set, and subsequently displaying the object.

14. The image processing method according to claim 13, further comprising:
adjusting the adjustment value set, when the specific information on the adjustment value set is input from the operation section.

15. The image processing method according to claim 13, further comprising:
adjusting the adjustment value set, when the specific information on the adjustment value set is input via an external input terminal portion.

16. The image processing method according to claim 13, further comprising:
adjusting the adjustment value set, when the specific information on the adjustment value set is input from a sensor or an antenna via a radio wave.

17. An image forming apparatus for processing an input image signal based on a specific adjustment value set, thereby to output an image comprising:
an operation section which receives specific information on the adjustment value set;
a display section which displays an object associated with the adjustment value set after the specific information is input to adjust the adjustment value set.

18. An image processing device comprising:
an image read section which reads an image of a read object to produce a first image signal;
an operation section which receives specific information on an adjustment value set for use in image processing to be applied to the first image signal;
a display section which displays an object associated with the adjustment value set after the specific information is input to adjust the adjustment value set;
a main control section which subjects the first image signal to the image processing based on the adjustment value set to produce and output a second image signal; and
an image forming section which forms an image based on the second image signal.
